(19) United States
(12) Patent Application Publication
(10) Pub. No.: US 2025/0317856 A1
(43) Pub. Date: Oct. 9, 2025

(54) RELAXED MEASUREMENT BASED ON WAKE-UP SIGNAL

(71) Applicant: Nokia Technologies Oy, Espoo (FI)

(72) Inventors: Muhammad TAYYAB, Oulu (FI); Jussi-Pekka KOSKINEN, Oulu (FI); Samuli Heikki TURTINEN, Oulu (FI)

(21) Appl. No.: 18/866,872

(22) PCT Filed: Jun. 15, 2023
(86) PCT No.: PCT/EP2023/066045

§ 371 Date: Nov. 18, 2024

(30) Foreign Application Priority Data
Jun. 23, 2022 (FI) 20225579

(51) Int. Cl. H04W 52/02; H04W 24/08; H04W 76/27

(52) U.S. Cl. CPC H04W 52/0235; H04W 24/08; H04W 76/27

(57) ABSTRACT

Disclosed is a method comprising evaluating one or more criteria for relaxed measurement on one or more radio cells, wherein at least a subset of the one or more criteria are associated with at least one signal comprising at least one of: a wake-up signal, a wake-up signal beacon, and a signal measured by a wake-up receiver; and determining, based on the evaluation, whether the relaxed measurement is allowed.

### FIELD

The following example embodiments relate to wireless communication.

### BACKGROUND

Relaxed measurement may be used to enable a terminal device to perform mobility-related measurements less frequently, for example. However, incorrect activation of relaxed measurement may lead to cell re-selection delay, or radio link or beam failure. Thus, it is desirable to avoid incorrect activations of relaxed measurement.

### BRIEF DESCRIPTION

The scope of protection sought for various example embodiments is set out by the independent claims. The example embodiments and features, if any, described in this specification that do not fall under the scope of the independent claims are to be interpreted as examples useful for understanding various embodiments.

According to an aspect, there is provided an apparatus comprising at least one processor, and at least one memory including computer program code, wherein the at least one memory and the computer program code are configured, with the at least one processor, to cause the apparatus to: evaluate one or more criteria for relaxed measurement on one or more radio cells, wherein at least a subset of the one or more criteria are associated with at least one signal comprising at least one of: a wake-up signal, a wake-up signal beacon, and a signal measured by a wake-up receiver; and determine, based on the evaluation, whether the relaxed measurement is allowed.

According to another aspect, there is provided an apparatus comprising means for: evaluating one or more criteria for relaxed measurement on one or more radio cells, wherein at least a subset of the one or more criteria are associated with at least one signal comprising at least one of: a wake-up signal, a wake-up signal beacon, and a signal measured by a wake-up receiver; and determining, based on the evaluation, whether the relaxed measurement is allowed.

According to another aspect, there is provided a method comprising: evaluating one or more criteria for relaxed measurement on one or more radio cells, wherein at least a subset of the one or more criteria are associated with at least one signal comprising at least one of: a wake-up signal, a wake-up signal beacon, and a signal measured by a wake-up receiver; and determining, based on the evaluation, whether the relaxed measurement is allowed.

According to another aspect, there is provided a computer program comprising instructions which, when executed by an apparatus, cause the apparatus to perform at least the following: evaluating one or more criteria for relaxed measurement on one or more radio cells, wherein at least a subset of the one or more criteria are associated with at least one signal comprising at least one of: a wake-up signal, a wake-up signal beacon, and a signal measured by a wake-up receiver; and determining, based on the evaluation, whether the relaxed measurement is allowed.

According to another aspect, there is provided a computer program comprising instructions for causing an apparatus to perform at least the following: evaluating one or more criteria for relaxed measurement on one or more radio cells, wherein at least a subset of the one or more criteria are associated with at least one signal comprising at least one of: a wake-up signal, a wake-up signal beacon, and a signal measured by a wake-up receiver; and determining, based on the evaluation, whether the relaxed measurement is allowed.

According to another aspect, there is provided a computer readable medium comprising program instructions for causing an apparatus to perform at least the following: evaluating one or more criteria for relaxed measurement on one or more radio cells, wherein at least a subset of the one or more criteria are associated with at least one signal comprising at least one of: a wake-up signal, a wake-up signal beacon, and a signal measured by a wake-up receiver; and determining, based on the evaluation, whether the relaxed measurement is allowed.

According to another aspect, there is provided a non-transitory computer readable medium comprising program instructions for causing an apparatus to perform at least the following: evaluating one or more criteria for relaxed measurement on one or more radio cells, wherein at least a subset of the one or more criteria are associated with at least one signal comprising at least one of: a wake-up signal, a wake-up signal beacon, and a signal measured by a wake-up receiver; and determining, based on the evaluation, whether the relaxed measurement is allowed.

According to another aspect, there is provided an apparatus comprising at least one processor, and at least one memory including computer program code, wherein the at least one memory and the computer program code are configured, with the at least one processor, to cause the apparatus to: indicate, to a user device, one or more criteria for relaxed measurement on one or more radio cells, wherein at least a subset of the one or more criteria are associated with at least one signal comprising at least one of: a wake-up signal, a wake-up signal beacon, and a signal measured by a wake-up receiver of the user device.

According to another aspect, there is provided an apparatus comprising means for: indicating, to a user device, one or more criteria for relaxed measurement on one or more radio cells, wherein at least a subset of the one or more criteria are associated with at least one signal comprising at least one of: a wake-up signal, a wake-up signal beacon, and a signal measured by a wake-up receiver of the user device.

According to another aspect, there is provided a method comprising: indicating, to a user device, one or more criteria for relaxed measurement on one or more radio cells, wherein at least a subset of the one or more criteria are associated with at least one signal comprising at least one of: a wake-up signal, a wake-up signal beacon, and a signal measured by a wake-up receiver of the user device.

According to another aspect, there is provided a computer program comprising instructions which, when executed by an apparatus, cause the apparatus to perform at least the following: indicating, to a user device, one or more criteria for relaxed measurement on one or more radio cells, wherein at least a subset of the one or more criteria are associated with at least one signal comprising at least one of: a wake-up signal, a wake-up signal beacon, and a signal measured by a wake-up receiver of the user device.

According to another aspect, there is provided a computer program comprising instructions for causing an apparatus to perform at least the following: indicating, to a user device, one or more criteria for relaxed measurement on one or more radio cells, wherein at least a subset of the one or more criteria are associated with at least one signal comprising at least one of: a wake-up signal, a wake-up signal beacon, and a signal measured by a wake-up receiver of the user device.

According to another aspect, there is provided a computer readable medium comprising program instructions for causing an apparatus to perform at least the following: indicating, to a user device, one or more criteria for relaxed measurement on one or more radio cells, wherein at least a subset of the one or more criteria are associated with at least one signal comprising at least one of: a wake-up signal, a wake-up signal beacon, and a signal measured by a wake-up receiver of the user device.

According to another aspect, there is provided a non-transitory computer readable medium comprising program instructions for causing an apparatus to perform at least the following: indicating, to a user device, one or more criteria for relaxed measurement on one or more radio cells, wherein at least a subset of the one or more criteria are associated with at least one signal comprising at least one of: a wake-up signal, a wake-up signal beacon, and a signal measured by a wake-up receiver of the user device.

### LIST OF DRAWINGS

In the following, various example embodiments will be described in greater detail with reference to the accompanying drawings, in which

FIG. 1 illustrates an example embodiment of a cellular communication network;

FIG. 2 illustrates representative power consumption profiles of discontinuous reception and wake-up signal;

FIG. 3 illustrates a signaling diagram according to an example embodiment;

FIG. 4 illustrates a signaling diagram according to an example embodiment;

FIG. 5 illustrates a flow chart according to an example embodiment;

FIG. 6 illustrates a flow chart according to an example embodiment;

FIG. 7 illustrates a flow chart according to an example embodiment;

FIG. 8 illustrates a flow chart according to an example embodiment;

FIG. 9 illustrates a flow chart according to an example embodiment;

FIG. 10 illustrates an example embodiment of an apparatus; and

FIG. 11 illustrates an example embodiment of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different example embodiments will be described using, as an example of an access architecture to which the example embodiments may be applied, a radio access architecture based on long term evolution advanced (LTE Advanced, LTE-A), new radio (NR, 5G), beyond 5G, or sixth generation (6G) without restricting the example embodiments to such an architecture, however. It is obvious for a person skilled in the art that the example embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

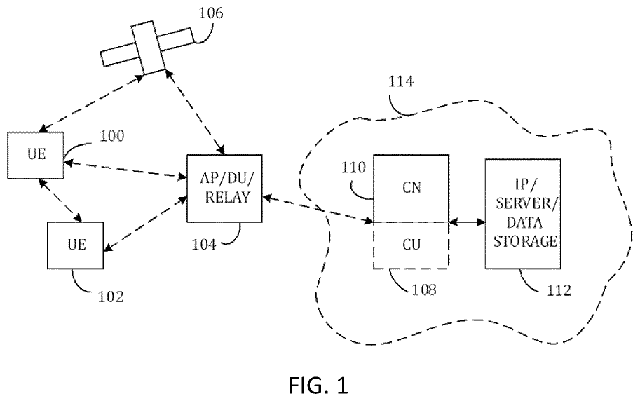

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The example embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a radio cell with an access node 104, such as an evolved Node B (abbreviated as eNB or eNodeB) or a next generation Node B (abbreviated as gNB or gNodeB), providing the radio cell. The physical link from a user device to an access node may be called uplink (UL) or reverse link, and the physical link from the access node to the user device may be called downlink (DL) or forward link. A user device may also communicate directly with another user device via sidelink (SL) communication. It should be appreciated that access nodes or their functionalities may be implemented by using any node, host, server or access point etc. entity suitable for such a usage.

A communication system may comprise more than one access node, in which case the access nodes may also be configured to communicate with one another over links, wired or wireless, designed for the purpose. These links may be used for signaling purposes. The access node may be a computing device configured to control the radio resources of communication system it is coupled to. The access node may also be referred to as a base station, a base transceiver station (BTS), an access point or any other type of interfacing device including a relay station capable of operating in a wireless environment. The access node may include or be coupled to transceivers. From the transceivers of the access node, a connection may be provided to an antenna unit that establishes bi-directional radio links to user devices. The antenna unit may comprise a plurality of antennas or antenna elements. The access node may further be connected to a core network 110 (CN or next generation core NGC). Depending on the system, the counterpart on the CN side may be a serving gateway (S-GW, routing and forwarding user data packets), packet data network gateway (P-GW) for providing connectivity of user devices to external packet data networks, user plane function (UPF), mobility management entity (MME), access and mobility management function (AMF), or location management function (LMF), etc.

The user device illustrates one type of an apparatus to which resources on the air interface may be allocated and assigned, and thus any feature described herein with a user device may be implemented with a corresponding apparatus, such as a relay node.

An example of such a relay node may be a layer 3 relay (self-backhauling relay) towards the access node. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and user device(s), and/or between the IAB node and other IAB nodes (multi-hop scenario).

Another example of such a relay node may be a layer 1 relay called a repeater. The repeater may amplify a signal received from an access node and forward it to a user device, and/or amplify a signal received from the user device and forward it to the access node.

The user device may also be called a subscriber unit, mobile station, remote terminal, access terminal, user terminal, terminal device, or user equipment (UE) just to mention but a few names or apparatuses. The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, multimedia device, reduced capability (RedCap) device, wireless sensor device, or any device integrated in a vehicle.

It should be appreciated that a user device may also be a nearly exclusive uplink-only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable or wearable device with radio parts (such as a watch, earphones or eyeglasses) and the computation may be carried out in the cloud or in another user device. The user device (or in some example embodiments a layer 3 relay node) may be configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may have multiple radio interfaces, namely below 6 GHz, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz−cmWave−mmWave). One of the concepts considered to be used in 5G networks may be network slicing, in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or an access node comprising radio parts. It may also be possible that node operations are distributed among a plurality of servers, nodes or hosts. Carrying out the RAN real-time functions at the RAN side (in a distributed unit, DU 104) and non-real time functions in a centralized manner (in a central unit, CU 108) may be enabled for example by application of cloudRAN architecture.

It should also be understood that the distribution of labour between core network operations and access node operations may differ from that of the LTE or even be non-existent. Some other technology advancements that may be used include big data and all-IP, which may change the way networks are being constructed and managed. 5G (or new radio, NR) networks may be designed to support multiple hierarchies, where MEC servers may be placed between the core and the access node. It should be appreciated that MEC may be applied in 4G networks as well.

5G may also utilize non-terrestrial communication, for example satellite communication, to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). At least one satellite 106 in the mega-constellation may cover several satellite-enabled network entities that create on-ground cells. The on-ground cells may be created through an on-ground relay node 104 or by a gNB located on-ground or in a satellite.

6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G may include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

It is obvious for a person skilled in the art that the depicted system is only an example of a part of a radio access system and in practice, the system may comprise a plurality of access nodes, the user device may have access to a plurality of radio cells and the system may also comprise other apparatuses, such as physical layer relay nodes or other network elements, etc. At least one of the access nodes may be a Home eNodeB or a Home gNodeB.

Furthermore, the access node may also be split into: a radio unit (RU) comprising a radio transceiver (TRX), i.e., a transmitter (Tx) and a receiver (Rx); one or more distributed units (DUs) that may be used for the so-called Layer 1 (L1) processing and real-time Layer 2 (L2) processing; and a central unit (CU) (also known as a centralized unit) that may be used for non-real-time L2 and Layer 3 (L3) processing. The CU may be connected to the one or more DUs for example by using an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU may be defined as a logical node hosting higher layer protocols, such as radio resource control (RRC), service data adaptation protocol (SDAP) and/or packet data convergence protocol (PDCP), of the access node. The DU may be defined as a logical node hosting radio link control (RLC), medium access control (MAC) and/or physical (PHY) layers of the access node. The operation of the DU may be at least partly controlled by the CU. The CU may comprise a control plane (CU-CP), which may be defined as a logical node hosting the RRC and the control plane part of the PDCP protocol of the CU for the access node. The CU may further comprise a user plane (CU-UP), which may be defined as a logical node hosting the user plane part of the PDCP protocol and the SDAP protocol of the CU for the access node.

Cloud computing platforms may also be used to run the CU and/or DU. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of labour between the above-mentioned access node units, or different core network operations and access node operations, may differ.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto-or picocells. The access node(s) of FIG. 1 may provide any kind of these cells. A cellular radio system may be implemented as a multilayer network including several kinds of radio cells. In multilayer networks, one access node may provide one kind of a radio cell or radio cells, and thus a plurality of access nodes may be needed to provide such a network structure.

For fulfilling the need for improving the deployment and performance of communication systems, the concept of “plug-and-play” access nodes may be introduced. A network which may be able to use “plug-and-play” access nodes, may include, in addition to Home eNodeBs or Home gNodeBs, a Home Node B gateway, or HNB-GW (not shown in FIG. 1). An HNB-GW, which may be installed within an operator's network, may aggregate traffic from a large number of Home eNodeBs or Home gNodeBs back to a core network.

Power saving mechanisms may be used to reduce UE power consumption. One such power saving mechanism is radio resource management (RRM) relaxation. RRM relaxation means less frequent measuring of the serving cell and/or one or more neighbor cells, such that the measurements are performed less frequently in order to reduce power consumption of the UE. RRM relaxation may also be referred to as relaxed monitoring or relaxed measurement. RRM relaxation comprises two components: RRM relaxation trigger, and RRM measurement relaxation.

The RRM relaxation trigger comprises one or more criteria, either configured to the UE or acquired by the UE from the serving cell, that are used to initiate RRM measurement relaxation. In NR Release 16, two RRM relaxation triggers, or criteria, have been specified for the UE: a low-mobility criterion, and a not-at-cell-edge criterion.

The low-mobility criterion aims to identify a UE in a low-mobility state. The low-mobility criterion is fulfilled, when:

$$( {Srxlev}_{Ref} - Srxlev ) < {S}_{SearchDeltaP} ,$$

where Srxlev is the current cell selection received level value (e.g., in dB) of the serving cell, and Srxlev_{Ref} is a reference received signal level value of the serving cell (e.g., in dB). For example, Srxlev may be a reference signal received power (RSRP) value, or a reference signal received quality (RSRQ) value, or a signal-to-interference-plus-noise ratio (SINR) value. Srxlev_{Ref} may be set or updated in three different ways: 1) after selecting or reselecting a new cell, or 2) if (Srxlev−Srxlev_{Ref})>(i.e., the UE is moving closer the cell center), or 3) if the low-mobility criterion has not been met for a time period T_{SearchDeltaP}, in which case the UE shall set the value of Srxlev_{Ref} to the current Srxlev value of the serving cell.

S_{SearchDeltaP} specifies the threshold (e.g., in dB) on Srxlev variation for relaxed measurement. T_{SearchDeltaP} specifies the time period over which the Srxlev variation is evaluated for relaxed measurement.

The not-at-cell-edge criterion aims to detect whether or not the UE is at the cell edge of the serving cell. If the not-at-cell-edge criterion is fulfilled, then it may mean that the UE is not at the cell edge of the serving cell. The not-at-cell-edge criterion is fulfilled, when:
Srxlev>S_{SearchTresholdP}, and
Squal>S_{SearchTresholdQ}, if S_{SearchTresholdQ} is configured
   where Srxlev is the current cell selection received level (e.g., in dB) of the serving cell, and S_{SearchTresholdP} is the Srxlev threshold value (e.g., in dB) for relaxed measurement.

Squal is the current cell selection quality value (e.g., in dB) of the serving cell, and S_{SearchTresholdQ} is the Squal threshold value (e.g., in dB) for relaxed measurement. For example, Squal may be an RSRQ value.

A given UE may be configured to monitor at least one of the RRM relaxation criteria. The network may configure the at least one RRM relaxation criteria (i.e., either the stationary/low-mobility criterion or the not-at-cell-edge criterion, or both) to the UE independently. In case the RRM relaxation is triggered with respect to its configuration, the UE may apply RRM measurement relaxation.

There are multiple ways to relax the RRM measurements, such as the cell to relax (e.g., whether to relax the serving cell or a neighbor cell), and how frequently to measure the relaxed cell (i.e., the measurement periodicity for the relaxed cell). In other words, in case the RRM relaxation is triggered, the UE may adjust the measurement periodicity for the serving cell and/or a neighbor cell in order to perform the RRM measurements less frequently. Relaxed measurements with longer intervals (scaling factor) can be configured. For example, the UE may stop the RRM measurements for up to 1 hour upon triggering the RRM relaxation.

Currently, UEs may need to periodically wake up once per discontinuous reception (DRX) cycle. When the UE wakes up, the power consumption of the UE increases. If UEs can wake up only when they are triggered (e.g., via paging), power consumption could be reduced. This can be achieved by using a wake-up signal (WUS) to trigger the main radio, and a separate receiver (wake-up receiver) that can monitor wake-up signals with ultra-low power consumption. The power consumption for monitoring wake-up signals depends on the wake-up signal design and the hardware module of the wake-up receiver used for signal detecting and processing.

The WUS operating principle is that in every wake-up cycle, called w-cycle, the wake-up receiver (WRx) monitors a set of specified subcarriers for a short duration of time to determine whether it receives a wake-up indicator (WI) or not. Through the WI, the network may inform the UE to decode the physical downlink control channel (PDCCH) with a specified time offset, called w-offset. Once the WRx successfully detects the WI, the baseband processor (BBP) will be switched on. After that, the BBP decodes the PDCCH messages at an active state for a preconfigured on-duration period, followed by the initiation of its inactivity timer. After the inactivity timer is initiated, and if a new PDCCH message is received before the timer expiration, the BBP re-initiates its inactivity timer. However, if there is no PDCCH message received before the expiration of the inactivity timer, a sleep period starts, the UE switches to its sleep state, and WRx operates according to its w-cycle.

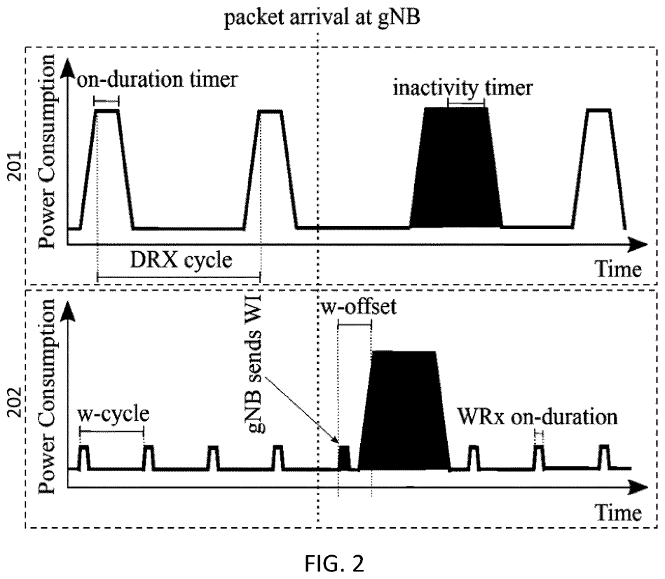

FIG. 2 illustrates representative power consumption profiles 201, 202 of DRX and WUS. Block 201 illustrates the power consumption profile of DRX, and block 202 illustrates the power consumption profile of WUS. In FIG. 2, the black areas indicate power consumption under scheduled PDCCH. As can be seen in FIG. 2, the WUS reduces the UE energy consumption compared to baseline DRX, as the energy consumption related to decoding unscheduled PDCCHs is avoided. Moreover, since the w-cycle can be short without essentially increasing the energy consumption, the buffering delay can be reduced compared to DRX.

Reduced capability (RedCap) devices may have lower complexity (e.g., reduced bandwidth and number of antennas), a longer battery life, and a smaller form factor than higher-end NR UEs. For example, a RedCap device may comprise 1 receiver branch and 1 transmitter branch (1Rx/1Tx), or 2 receiver branches and 1 transmitter branch (2Rx/1Tx), in both frequency range 1 (FR1) and frequency range 2 (FR2). RedCap devices may support all FR1 and FR2 bands for frequency-division duplexing (FDD) and time-division duplexing (TDD). Some examples of RedCap devices may include (but are not limited to) industrial wireless sensors, video surveillance cameras, and wearables (e.g., smart watches, rings, eHealth-related devices, personal protection equipment, medical monitoring devices, etc.). RedCap devices may also be referred to as NR-Lite devices or NR-Light devices.

Even when applying the RRM relaxation feature considering both the low-mobility and not-at-cell-edge criteria for RedCap devices, the RRM relaxation feature may cause the following issues (1-3):
1. With the dynamic coverage due to mobility in the environment and changing weather conditions, UEs may need to change the cell they are connected to or camping on. A sudden drop in the reference signal received power (RSRP) value could be associated with, for example, an abrupt change in UE speed (e.g., RedCap device in bicycle, car, etc), a change in distance (re-locating the RedCap device within home/office), or obstacles. Thus, more frequent sensing of the environment may be needed.
2. When serving cell relaxation is enabled in beam-based communication, the serving beams used for deriving the cell quality may change, while the UE is in a relaxation state. In other words, the UE may be mobile or re-located, but based on current criteria it could still relax measurements. This might lead to beam failure or radio link failure.
3. High relaxation (e.g., up to 1 hour) may degrade the network performance, for example due to too late handover or radio link failure, which impacts UE throughput and nullifies the gain in terms of energy saving.

All of the above issues may result in inefficient RRM relaxation decisions, i.e., measurements may be relaxed when they should not be relaxed, or they are not relaxed in the situations suitable for relaxation.

Some example embodiments are described below using principles and terminology of 5G technology without limiting the example embodiments to 5G communication systems, however.

Some example embodiments may provide a solution to dynamically adjust the RRM relaxation decision by continuously monitoring the RRM relaxation condition using, for example, the wake-up signal after the UE has activated the RRM relaxation feature.

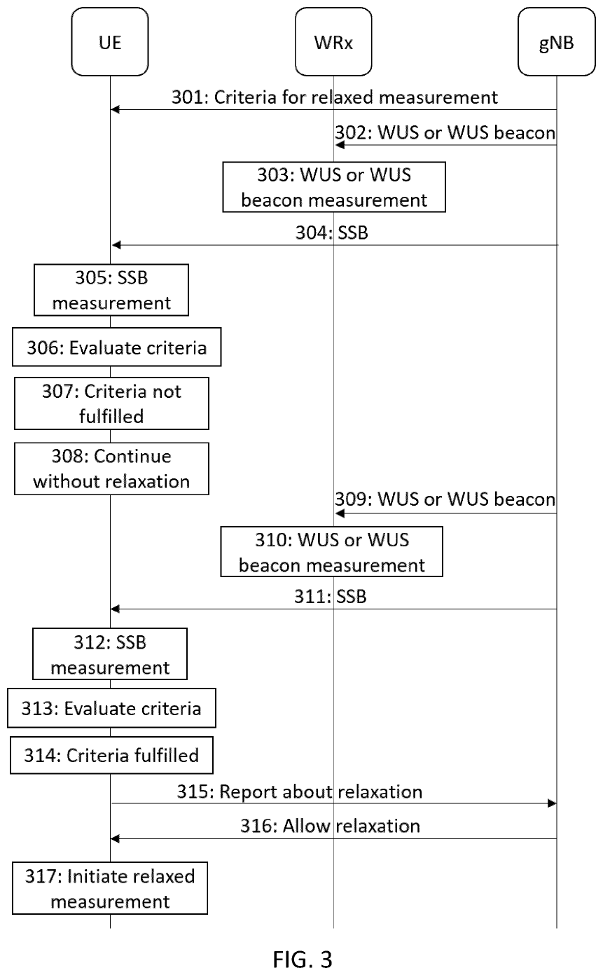

FIG. 3 illustrates a signaling diagram according to an example embodiment.

Referring to FIG. 3, in block 301, a network element such as a gNB configures a UE with one or more criteria for relaxed measurement on one or more radio cells. The one or more radio cells may comprise, for example, the serving cell of the UE and/or one or more neighbor cells of the serving cell. The serving cell may be provided by the gNB (i.e., the gNB may be the serving gNB of the UE). This configuration can be done using broadcast (e.g., system information) and/or dedicated signaling, such as an RRC Reconfiguration or RRC Release message.

The relaxed measurement may comprise at least one of: RRM relaxation, radio link monitoring (RLM) relaxation, and/or beam failure detection (BFD) relaxation criteria.

The one or more criteria may be related to “WUS/WUS beacon” or “WUS/WUS beacon and RRM/RLM/BFD”. In other words, the one or more criteria may comprise WUS-based relaxation criteria and/or RRM/RLM/BFD relaxation criteria (e.g., low-mobility criterion and/or not-at-cell-edge criterion).

RRM relaxation criteria may be applicable to RRC_IDLE, RRC_INACTIVE and RRC_CONNECTED states. RLM and BFD relaxation criteria may be applicable to RRC_CONNECTED and/or RRC_INACTIVE states.

In block 302, a wake-up receiver (WRx) monitors and receives at least one signal. The at least one signal may comprise, for example, a WUS or WUS beacon, or both. Alternatively, the at least one signal may comprise a synchronization signal or any other signal received by the wake-up receiver. The wake-up receiver may be comprised in the UE.

The WUS beacon is used for synchronization purposes (to keep the wake-up receiver synchronized and also possibly to keep different “cells” transmitting WUS in a synchronized manner), and it is constantly transmitted in WUS beacon occasions, i.e., it is transmitted even if WUS is not transmitted. WUS then indicates whether the UE shall wake up for paging monitoring.

In block 303, the WRx performs measurements on the received at least one signal. For example, the WRx may measure path loss and/or signal strength of the WUS or WUS beacon (or other signal received by the WRx).

In block 304, the UE receives a synchronization signal block (SSB) from the gNB.

In block 305, the UE performs SSB measurement of the received SSB.

In block 306, the UE evaluates, or monitors, the one or more criteria to determine whether RRM/RLM/BFD relaxation is allowed or not.

In one example, wake-up signal (WUS) criteria is monitored after other relaxation condition (e.g., low-mobility criterion or not-at-cell-edge criterion or both) is fulfilled.

In another example, wake-up signal (WUS) criteria is monitored upon it is configured.

In another example, a low-power WUS from the gNB to the UE may be used to dynamically adjust the UE decision about RRM/RLM/BFD relaxation upon identifying (a sudden) drop in path loss.

In another example, WUS path loss is estimated at the wake-up receiver (WRx) side, and when the path loss is above one or more first pre-defined thresholds, re-evaluation of RRM relaxation criteria is triggered at the UE side.

In another example, the UE is allowed to relax RRM/RLM/BFD measurements in case signal strength of the WUS or WUS beacon (or other signal received by WRx) is above one or more second pre-defined thresholds. For example, the signal strength may comprise one of: RSRP, SINR, signal-to-noise ratio (SNR), or received signal strength indicator (RSSI). In other words, the one or more criteria may comprise at least a criterion for a signal strength of the at least one signal being above or equal to one or more second pre-defined thresholds. The one or more second thresholds may comprise, for example, a single threshold or two separate thresholds for the serving cell and a neighboring cell, respectively.

In another example, the one or more criteria may comprise at least a criterion for a variation of the signal strength being less than or equal to one or more third pre-defined thresholds. In this case, the UE may be allowed to relax RRM/RLM/BFD measurements in case the signal strength of the at least one signal (e.g., WUS) is constant, i.e., no variation in the measurement results or the variation is small enough, for example less than +/−a certain amount of db. The one or more third thresholds may comprise, for example, a single threshold or two separate thresholds for the serving cell and a neighboring cell, respectively.

In another example, the UE shall receive a certain amount of wake-up signals or WUS beacons (or other signals received by WRx) during a certain time period in order that relaxation is allowed. In other words, the one or more criteria may comprise at least a criterion for receiving a pre-defined number of signals within a pre-defined time period.

In another example, in case the UE cannot decode the WUS for a certain number of times (e.g., one, two, or configurable number of times), the relaxation is not allowed. In other words, the one or more criteria may comprise at least a criterion for a number of decoding failures associated with the at least one signal being below or equal to one or more fourth pre-defined thresholds. The one or more fourth thresholds may comprise, for example, a single threshold or two separate thresholds for the serving cell and a neighboring cell, respectively.

Herein the terms “first threshold”, “second threshold”, “third threshold”, and “fourth threshold” are used to distinguish the thresholds, and they do not necessarily mean a specific order or specific indices of the thresholds.

In block 307, the UE determines, based on the evaluation, that RRM/RLM/BFD relaxation is not allowed (i.e., the one or more criteria are not fulfilled).

In block 308, the UE continues RRM/RLM/BFD measurements without relaxation.

In block 309, the WRx monitors and receives another WUS or WUS beacon or both (or other signal).

In block 310, the WRx performs measurements on the received signal (i.e., the signal received in block 309). For example, the WRx may measure path loss and/or signal strength of the WUS or WUS beacon (or other signal received by WRx).

In block 311, the UE receives another SSB from the gNB.

In block 312, the UE performs SSB measurement to measure the SSB received from the gNB in block 311.

In block 313, the UE evaluates the one or more criteria to determine whether RRM/RLM/BFD relaxation is allowed or not (similar to block 306).

In block 314, the UE determines, based on the evaluation of block 313, that RRM/RLM/BFD relaxation is allowed (i.e., the one or more criteria are fulfilled).

In block 315, the UE may report to the gNB that the one or more criteria are fulfilled or that the UE started the relaxation. However, it should be noted that this report may be optional, i.e., it may not necessarily be needed.

In block 316, the gNB may transmit an indication to the UE to allow and/or configure the RRM/RLM/BFD relaxation. However, it should be noted that this indication may be optional, i.e., it may not necessarily be needed.

In block 317, the UE starts, or initiates, relaxed RRM/RLM/BFD measurement. The UE may initiate the relaxed measurement in response to receiving the allowance indication from the gNB (block 316) or in response to determining that the one or more criteria are fulfilled (block 314). The RRM/RLM/BFD relaxation may comprise one or more of the following (a-c):
a. RRM/RLM/BFD measurements are not performed at all. In this case, RRM/RLM/BFD measurements are resumed, when the one or more criteria are not fulfilled anymore or exit condition is fulfilled
b. RRM/RLM/BFD measurements are relaxed in time and/or frequency until the one or more criteria are not fulfilled anymore or exit condition is fulfilled.
c. RRM/RLM/BFD relaxation is performed according to legacy, i.e., NR Release 16 or 17, relaxations.

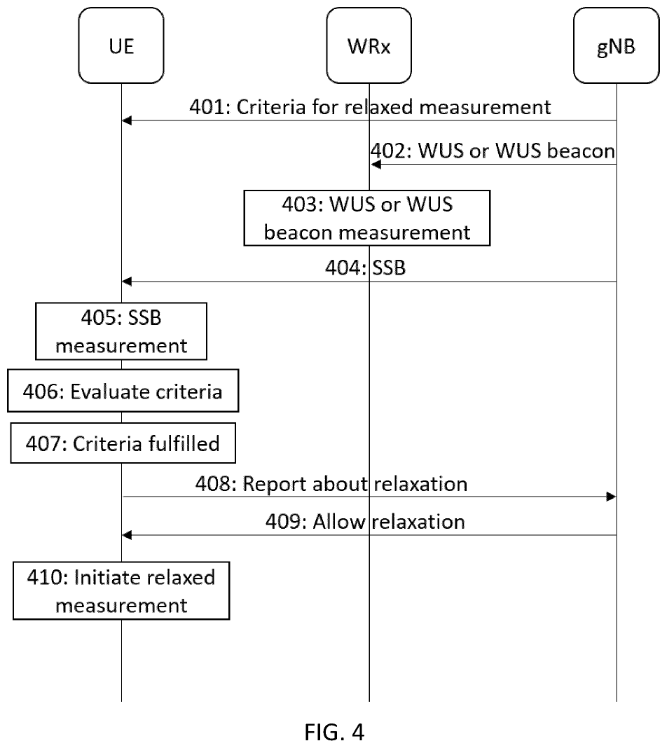

FIG. 4 illustrates a signaling diagram according to another example embodiment.

Referring to FIG. 4, in block 401, a network element such as a gNB configures a UE with one or more criteria for relaxed measurement on one or more radio cells. This configuration can be done using broadcast (e.g., system information) and/or dedicated signaling, such as an RRC Reconfiguration or RRC Release message.

The relaxed measurement may comprise at least one of: RRM relaxation, radio link monitoring (RLM) relaxation, and/or beam failure detection (BFD) relaxation criteria.

The one or more criteria may be related to “WUS/WUS beacon” or “WUS/WUS beacon and RRM/RLM/BFD”. In other words, the one or more criteria may comprise WUS-based relaxation criteria and/or RRM/RLM/BFD relaxation criteria (e.g., low mobility criterion and/or not-at-cell-edge criterion).

RRM relaxation criteria may be applicable to RRC_IDLE, RRC_INACTIVE and RRC_CONNECTED states. RLM and BFD relaxation criteria may be applicable to RRC_CONNECTED state.

In block 402, the WRx monitors and receives at least one signal (e.g., WUS and/or WUS beacon, or some other signal).

In block 403, the WRx performs measurements on the received at least one signal. For example, the WRx may measure path loss and/or signal strength of the at least one signal.

In block 404, the UE receives an SSB from the gNB.

In block 405, the UE performs SSB measurement to measure the SSB received from the gNB.

In block 406, the UE evaluates the one or more criteria to determine whether RRM/RLM/BFD relaxation is allowed or not (as described above with reference to block 306 of FIG. 3).

In block 407, based on the evaluation, the UE determines that RRM/RLM/BFD relaxation is allowed (i.e., the one or more criteria are fulfilled).

In block 408, the UE may report to the gNB that the one or more criteria are fulfilled or that the UE started the relaxation. However, it should be noted that this report may be optional, i.e., it may not necessarily be needed.

In block 409, the gNB may transmit an indication to the UE to allow and/or configure the RRM/RLM/BFD relaxation. However, it should be noted that this indication may be optional, i.e., it may not necessarily be needed.

In block 410, the UE starts, or initiates, relaxed RRM/RLM/BFD measurement.

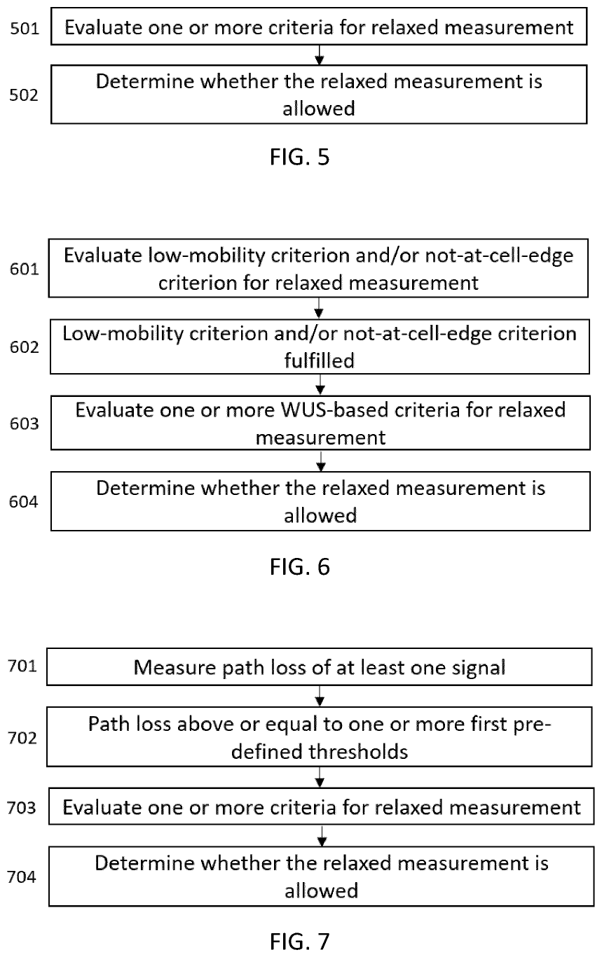

FIG. 5 illustrates a flow chart according to an example embodiment of a method performed by an apparatus such as, or comprising, or comprised in, a user device. The user device may also be called a subscriber unit, mobile station, remote terminal, access terminal, user terminal, terminal device, or user equipment (UE). The user device may correspond to one of the user devices 100, 102 of FIG. 1. The user device may be, for example, a reduced capability (RedCap) device or any other type of UE. The apparatus may comprise a main radio receiver and/or a wake-up receiver.

Referring to FIG. 5, in block 501, one or more criteria for relaxed measurement on one or more radio cells are evaluated, wherein at least a subset of the one or more criteria are associated with at least one signal comprising at least one of: a wake-up signal, a wake-up signal beacon, and/or a signal measured by a wake-up receiver. In other words, at least one of the one or more criteria may be associated with the at least one signal. The wake-up signal or the wake-up signal beacon may be measured, or received, by the main radio receiver or by the wake-up receiver of the apparatus. The signal measured by the wake-up receiver may refer to, for example, a wake-up signal, a wake-up signal beacon, a synchronization signal, or any other signal.

The at least subset of the one or more criteria may be applicable to any of the following: radio resource control connected state (RRC_CONNECTED), radio resource control idle state (RRC_IDLE), and/or radio resource control inactive state (RRC_INACTIVE).

The one or more radio cells may comprise at least a serving cell and/or a neighboring cell. In case the one or more radio cells comprise both the serving cell and the neighboring cell, the method can be used to relax both the serving cell and the neighboring cell by defining the same or two different thresholds for the one or more criteria (e.g., threshold1 for serving cell relaxation re-evaluation, and threshold2 for neighboring cell relaxation evaluation).

For example, the one or more criteria may comprise at least a criterion for a signal strength of the at least one signal being above or equal to one or more second pre-defined thresholds. In this case, the UE may be allowed to relax RRM/RLM/BFD measurements in case the signal strength of the at least one signal (e.g., WUS) is above the one or more second thresholds. The one or more second thresholds may comprise, for example, a single threshold or two separate thresholds for the serving cell and a neighboring cell, respectively.

Alternatively, or additionally, the one or more criteria may comprise at least a criterion for a variation of the signal strength being less than or equal to one or more third pre-defined thresholds. In this case, the UE may be allowed to relax RRM/RLM/BFD measurements in case the signal strength of the at least one signal (e.g., WUS) is constant, i.e., no variation in the measurement results or the variation is small enough, for example less than +/−a certain amount of db. The one or more third thresholds may comprise, for example, a single threshold or two separate thresholds for the serving cell and a neighboring cell, respectively.

Alternatively, or additionally, the one or more criteria may comprise at least a criterion for receiving a pre-defined number of signals within a pre-defined time period. In this case, the UE shall receive a certain amount of signals (e.g., WUS) during a certain time period in order that relaxation is allowed.

Alternatively, or additionally, the one or more criteria may comprise at least a criterion for a number of decoding failures associated with the at least one signal being below or equal to one or more fourth pre-defined thresholds. In this case, if the UE cannot decode the at least one signal (e.g., WUS) for a certain number of times (e.g., one, two, or a configurable number of times), the relaxation is not allowed. The one or more fourth thresholds may comprise, for example, a single threshold or two separate thresholds for the serving cell and a neighboring cell, respectively.

In block 502, the apparatus determines, based on the evaluation, whether the relaxed measurement is allowed. The relaxed measurement may be allowed, if the one or more criteria are fulfilled. The relaxed measurement may comprise at least one of: radio resource management (RRM) relaxation, radio link monitoring (RLM) relaxation, and/or beam failure detection (BFD) relaxation.

FIG. 6 illustrates a flow chart according to another example embodiment of a method performed by an apparatus such as, or comprising, or comprised in, a user device. The user device may also be called a subscriber unit, mobile station, remote terminal, access terminal, user terminal, terminal device, or user equipment (UE). The user device may correspond to one of the user devices 100, 102 of FIG. 1. The user device may be, for example, a reduced capability (RedCap) device or any other type of UE. The apparatus may comprise a main radio receiver and/or a wake-up receiver.

Referring to FIG. 6, in block 601, a low-mobility criterion and/or a not-at-cell-edge criterion for relaxed measurement on one or more radio cells are evaluated. The low-mobility criterion and the not-at-cell-edge criterion are described above in further detail.

in block 602, the apparatus determines that at least one or both of the low-mobility criterion and/or the not-at-cell-edge criterion are fulfilled.

In block 603, in response to fulfilling the at least one or both of the low-mobility criterion and/or the not-at-cell-edge criterion, one or more other criteria for relaxed measurement on the one or more radio cells are evaluated, wherein at least a subset of the one or more other criteria are associated with at least one signal comprising at least one of: a wake-up signal, a wake-up signal beacon, and a signal measured by a wake-up receiver. The wake-up signal or the wake-up signal beacon may be measured, or received, by the main radio receiver or by the wake-up receiver of the apparatus. The signal measured by the wake-up receiver may refer to, for example, a wake-up signal, a wake-up signal beacon, a synchronization signal, or any other signal.

In block 604, the apparatus determines, based on the evaluation of block 603, whether the relaxed measurement is allowed.

FIG. 7 illustrates a flow chart according to another example embodiment of a method performed by an apparatus such as, or comprising, or comprised in, a user device. The user device may also be called a subscriber unit, mobile station, remote terminal, access terminal, user terminal, terminal device, or user equipment (UE). The user device may correspond to one of the user devices 100, 102 of FIG. 1. The user device may be, for example, a reduced capability (RedCap) device or any other type of UE. The apparatus may comprise a main radio receiver and/or a wake-up receiver.

In this example embodiment, path loss of at least one signal (e.g., WUS) may be estimated at the wake-up receiver (WRx) side, and when the path loss is above or equal to one or more first pre-defined thresholds, (re-)evaluation of the relaxation criteria is triggered at the UE side.

Referring to FIG. 7, in block 701, a path loss of at least one signal is measured, wherein the at least one signal comprises at least one of: a wake-up signal, a wake-up signal beacon, and/or a signal measured by a wake-up receiver. The wake-up signal or the wake-up signal beacon may be measured, or received, by the main radio receiver or by the wake-up receiver of the apparatus. The signal measured by the wake-up receiver may refer to, for example, a wake-up signal, a wake-up signal beacon, a synchronization signal, or any other signal.

The path loss may be available at the wake-up receiver (WRx) side, which can measure path loss from the received at least one signal (e.g., WUS) assuming that the transmit power of the at least one signal is known to the UE. The WUS may be transmitted every wake-up cycle, called the w-cycle. The UE may send an indication to the WRx to indicate that RRM relaxation is enabled. Upon receiving the indication, the WRx may compute the path loss of N received WUS to get an average path loss value denoted as Initial_PL_{WUS}:

$${Initial\_PL}_{WUS} = average ( N received wakeup signal pathloss )$$

Initial_PL_{WUS} may also be referred to as a first path loss value, which indicates an average of a first plurality of measured path loss values.

Next, the WRx may compute a current path loss denoted as Current_PL_{WUS}, which considers an average of the last M measurements:

$${Current\_PL}_{WUS} = average ( N last received wakeup signal pathloss )$$

Current_PL_{WUS} may also be referred to as a second path loss value, which indicates an average of a second plurality of measured path loss values. The second plurality of measured path loss values may comprise more recent (i.e., newer) values than the first plurality of measured path loss values. In other words, the first plurality of measured path loss may be measured over a first time window, and the second plurality of measured path loss values may be measured over a second time window that is later in time than the first time window.

The measurement over 1 to N or 1 to M received WUS may be averaged to filter out the possible outlier values caused by measurement errors.

The WRx may then compute a path loss offset value denoted as PL_{offset-WS}, which indicates the difference between the first path loss value Initial_PL_{WUS} and the second path loss value Current_PL_{WUS}:

$${PL}_{offset - WS} = {Current}_{{PL}_{WS}} - {Initial}_{{PL}_{WS}}$$

In other words, the path loss measured in block 701 may comprise the offset value PL_{offset-WS} between the first path loss value Initial_PL_{WUS} and the second path loss value Current_PL_{WUS}.

In block 702, the path loss (e.g., PL_{offset-WS}) of the at least one signal is determined to be above or equal to one or more first pre-defined thresholds.

The one or more first pre-defined thresholds may be used to indicate how much path loss variations are acceptable (e.g., 5 dB, 10 dB, etc.). If the path loss variations are within a specified threshold (e.g., below the one or more first pre-defined threshold), the RRM relaxation criteria will not be re-evaluated.

In one example, the network (e.g., gNB) may indicate the one or more first thresholds (e.g., threshold1 and threshold2) to the UE with initial settings. In another example, the UE can control the threshold settings and inform the network (e.g., gNB) about this. An alternative way is to allow the network (e.g., gNB) to configure a common assistance value for the threshold(s) so that the UE can set a customized threshold that fits the UE's circumstances.

For example, if PL_{offset-WS}>threshold1, then the UE may be triggered to (re-)evaluate whether the relaxed measurement, e.g., for the serving cell, is allowed.

As another example, is PL_{offset-WS}>threshold2, then the UE may update the neighboring cell RRM relaxation criteria.

In block 703, in response to the path loss of the at least one signal being above or equal to the one or more first pre-defined thresholds (e.g., PL_{offset-WS}>threshold1), one or more criteria for relaxed measurement on one or more radio cells are evaluated.

In block 704, the apparatus determines, based on the evaluation, whether the relaxed measurement is allowed.

If any of the above criteria are not satisfied, the UE may stop the relaxation and send an indication to the network.

The process may be iterative such that the process returns to block 701 after block 704. The process of continuously monitoring the relaxation criteria using WUS path loss may work better, when channel gain variability is largely due to the frequent appearance of obstacles in the dynamic network environment. In addition, the process can be used to re-estimate the cell quality when the UE changes its beam, and based on that, it can re-evaluate the RRM relaxation decision.

FIG. 8 illustrates a flow chart according to another example embodiment of a method performed by an apparatus such as, or comprising, or comprised in, a user device. The user device may also be called a subscriber unit, mobile station, remote terminal, access terminal, user terminal, terminal device, or user equipment (UE). The user device may correspond to one of the user devices 100, 102 of FIG. 1. The user device may be, for example, a reduced capability (RedCap) device or any other type of UE. The apparatus may comprise a main radio receiver and/or a wake-up receiver.

Referring to FIG. 8, in block 801, one or more criteria for relaxed measurement on one or more radio cells are evaluated, wherein at least a subset of the one or more criteria are associated with at least one signal comprising at least one of: a wake-up signal, a wake-up signal beacon, and/or a signal measured by a wake-up receiver. The wake-up signal or the wake-up signal beacon may be measured, or received, by the main radio receiver or by the wake-up receiver of the apparatus. The signal measured by the wake-up receiver may refer to, for example, a wake-up signal, a wake-up signal beacon, a synchronization signal, or any other signal.

In block 802, the apparatus determines, based on the evaluation, whether the relaxed measurement is allowed.

In block 804, if the relaxed measurement is allowed based on the determination (block 803: yes), i.e., if the one or more criteria are fulfilled based on the evaluation, then the relaxed measurement is initiated on the one or more radio cells, or the relaxed measurement is continued if it is already active.

Alternatively, in block 805, if the relaxed measurement is not allowed based on the determination (block 803: no), i.e., if the one or more criteria are not fulfilled based on the evaluation, then the relaxed measurement is not initiated, or the relaxed measurement is stopped if it is currently active. In other words, if one or more or all of the relaxation criteria (WUS-based or RRM/RLM/BFD relaxation criteria) is not fulfilled, the UE stops the relaxation.

In block 806, following block 805, the UE may transmit a signal or indication to the network element (e.g., gNB) about its decision to indicate the stopping of the relaxed measurement.

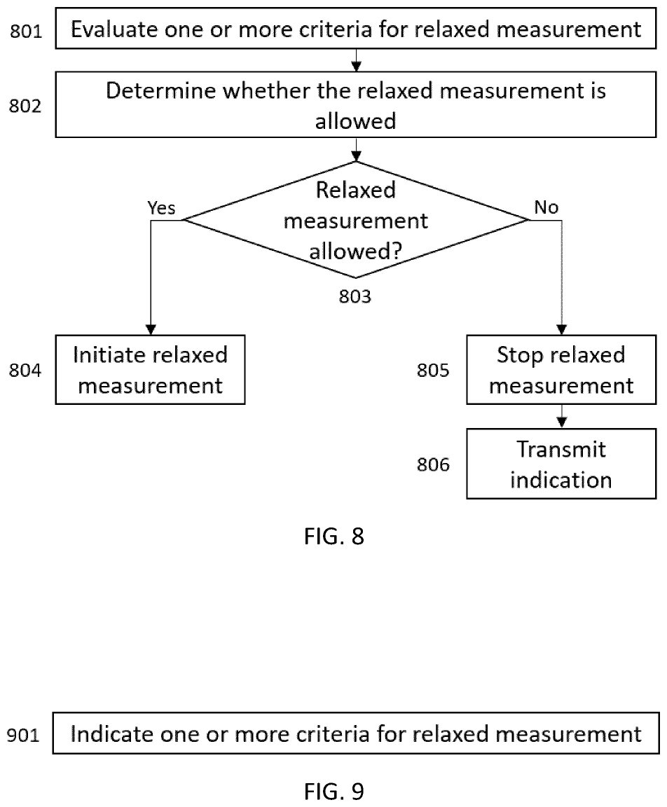

FIG. 9 illustrates a flow chart according to an example embodiment of a method performed by an apparatus such as, or comprising, or comprised in, a network element of a radio access network. The network element may correspond to the access node 104 of FIG. 1.

Referring to FIG. 9, in block 901, one or more criteria for relaxed measurement on one or more radio cells are indicated to a user device, wherein at least a subset of the one or more criteria are associated with at least one signal comprising at least one of: a wake-up signal, a wake-up signal beacon, and a signal measured by a wake-up receiver of the user device. The wake-up signal or the wake-up signal beacon may be measured, or received, by the main radio receiver or by the wake-up receiver of the user device. The signal measured by the wake-up receiver may refer to, for example, a wake-up signal, a wake-up signal beacon, a synchronization signal, or any other signal.

The at least subset of the one or more criteria may be applicable to any of the following: radio resource control connected state (RRC_CONNECTED), radio resource control idle state (RRC_IDLE), and/or radio resource control inactive state (RRC_INACTIVE).

The relaxed measurement may comprise at least one of: radio resource management (RRM) relaxation, radio link monitoring (RLM) relaxation, and/or beam failure detection (BFD) relaxation.

The blocks, related functions, and information exchanges (messages) described above by means of FIGS. 3-9 are in no absolute chronological order, and some of them may be performed simultaneously or in an order differing from the described one. Other functions can also be executed between them or within them, and other information may be sent, and/or other rules applied. Some of the blocks or part of the blocks or one or more pieces of information can also be left out or replaced by a corresponding block or part of the block or one or more pieces of information.

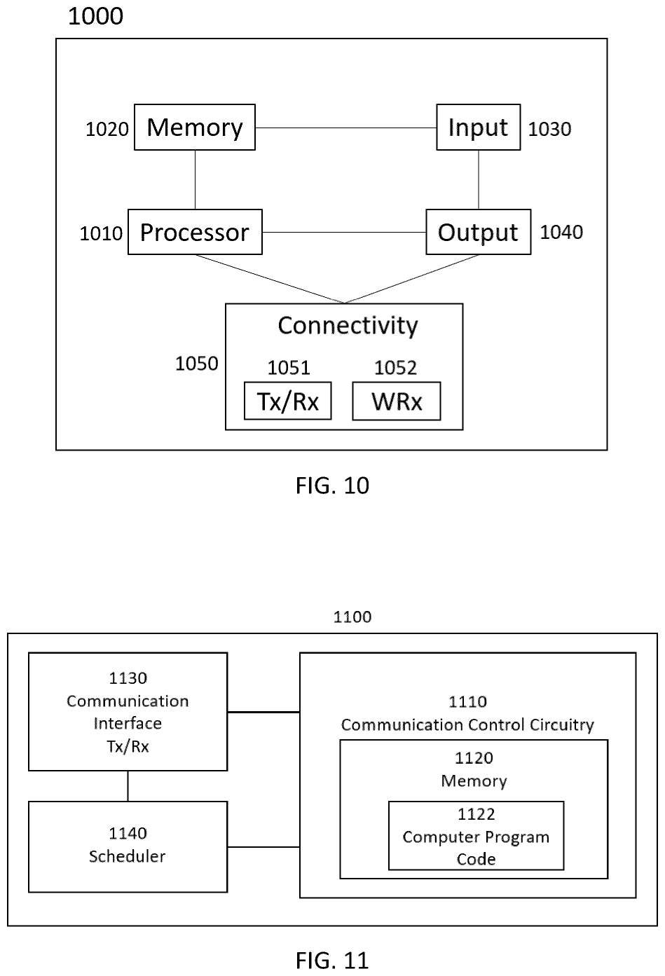

FIG. 10 illustrates an example embodiment of an apparatus 1000, which may be an apparatus such as, or comprising, or comprised in, a user device. The user device may correspond to one of the user devices 100, 102 of FIG. 1. The user device may also be called a subscriber unit, mobile station, remote terminal, access terminal, user terminal, terminal device, or user equipment (UE).

The apparatus 1000 comprises at least one processor 1010. The at least one processor 1010 interprets computer program instructions and processes data. The at least one processor 1010 may comprise one or more programmable processors. The at least one processor 1010 may comprise programmable hardware with embedded firmware and may, alternatively or additionally, comprise one or more application-specific integrated circuits (ASICs).

The at least one processor 1010 is coupled to at least one memory 1020. The at least one processor is configured to read and write data to and from the at least one memory 1020. The at least one memory 1020 may comprise one or more memory units. The memory units may be volatile or non-volatile. It is to be noted that in some example embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The at least one memory 1020 stores computer readable instructions that are executed by the at least one processor 1010 to perform one or more of the example embodiments described above. For example, non-volatile memory stores the computer readable instructions, and the at least one processor 1010 executes the instructions using volatile memory for temporary storage of data and/or instructions.

The computer readable instructions may have been pre-stored to the at least one memory 1020 or, alternatively or additionally, they may be received, by the apparatus, via an electromagnetic carrier signal and/or may be copied from a physical entity such as a computer program product. Execution of the computer readable instructions causes the apparatus 1000 to perform one or more of the functionalities described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer.

The apparatus 1000 may further comprise, or be connected to, an input unit 1030. The input unit 1030 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 1030 may comprise an interface to which external devices may connect to.

The apparatus 1000 may also comprise an output unit 1040. The output unit may comprise or be connected to one or more displays capable of rendering visual content, such as a light emitting diode (LED) display, a liquid crystal display (LCD) and/or a liquid crystal on silicon (LCoS) display. The output unit 1040 may further comprise one or more audio outputs. The one or more audio outputs may be for example loudspeakers.

The apparatus 1000 further comprises a connectivity unit 1050. The connectivity unit 1050 enables wireless connectivity to one or more external devices. The connectivity unit 1050 may comprise at least one transmitter and at least one receiver 1051 that may be integrated to the apparatus 1000 or that the apparatus 1000 may be connected to. The at least one transmitter comprises at least one transmission antenna, and the at least one receiver comprises at least one receiving antenna. The connectivity unit 1050 may further comprise a wake-up receiver (WRx) 1052 for monitoring wake-up signals and/or wake-up signal beacons. The connectivity unit 1050 may comprise an integrated circuit or a set of integrated circuits that provide the wireless communication capability for the apparatus 1000. Alternatively, the wireless connectivity may be a hardwired application-specific integrated circuit (ASIC). The connectivity unit 1050 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

It is to be noted that the apparatus 1000 may further comprise various components not illustrated in FIG. 10. The various components may be hardware components and/or software components.

The apparatus 1100 of FIG. 11 illustrates an example embodiment of an apparatus such as, or comprising, or comprised in, a network element of a radio access network. The network element may correspond to the access node 104 of FIG. 1. The network element may also be referred to, for example, as a network node, a radio access network (RAN) node, a next generation radio access network (NG-RAN) node, a NodeB, an eNB, a gNB, a base transceiver station (BTS), a base station, an NR base station, a 5G base station, an access node, an access point (AP), a relay node, a repeater, an integrated access and backhaul (IAB) node, an IAB donor node, a distributed unit (DU), a central unit (CU), a baseband unit (BBU), a radio unit (RU), a radio head, a remote radio head (RRH), or a transmission and reception point (TRP).

The apparatus 1100 may comprise, for example, a circuitry or a chipset applicable for realizing one or more of the example embodiments described above. The apparatus 1100 may be an electronic device comprising one or more electronic circuitries. The apparatus 1100 may comprise a communication control circuitry 1110 such as at least one processor, and at least one memory 1120 storing instructions which, when executed by the at least one processor, cause the apparatus 1100 to carry out one or more of the example embodiments described above. Such instructions may, for example, include a computer program code (software) 1122 wherein the at least one memory and the computer program code (software) 1122 are configured, with the at least one processor, to cause the apparatus 1100 to carry out some of the example embodiments described above. Herein computer program code may in turn refer to instructions that cause the apparatus 1100 to perform one or more of the example embodiments described above. That is, the at least one processor and the at least one memory 1120 storing the instructions may cause said performance of the apparatus.

The processor is coupled to the memory 1120. The processor is configured to read and write data to and from the memory 1120. The memory 1120 may comprise one or more memory units. The memory units may be volatile or non-volatile. It is to be noted that in some example embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 1120 stores computer readable instructions that are executed by the processor. For example, non-volatile memory stores the computer readable instructions and the processor executes the instructions using volatile memory for temporary storage of data and/or instructions.

The computer readable instructions may have been pre-stored to the memory 1120 or, alternatively or additionally, they may be received, by the apparatus, via an electromagnetic carrier signal and/or may be copied from a physical entity such as a computer program product. Execution of the computer readable instructions causes the apparatus 1100 to perform one or more of the functionalities described above.

The memory 1120 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data. For example, the configuration database may store a current neighbour cell list, and, in some example embodiments, structures of the frames used in the detected neighbour cells.

The apparatus 1100 may further comprise a communication interface 1130 comprising hardware and/or software for realizing communication connectivity according to one or more communication protocols. The communication interface 1130 comprises at least one transmitter (Tx) and at least one receiver (Rx) that may be integrated to the apparatus 1100 or that the apparatus 1100 may be connected to. The communication interface 1130 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

The communication interface 1130 provides the apparatus with radio communication capabilities to communicate in the cellular communication system. The communication interface may, for example, provide a radio interface to one or more user devices. The apparatus 1100 may further comprise another interface towards a core network such as the network coordinator apparatus and/or to the access nodes of the cellular communication system.

The apparatus 1100 may further comprise a scheduler 1140 that is configured to allocate radio resources. The scheduler 1140 may be configured along with the communication control circuitry 1110 or it may be separately configured.

It is to be noted that the apparatus 1100 may further comprise various components not illustrated in FIG. 11. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the example embodiments described above, but may vary within the scope of the claims. Therefore, all words and expressions should be interpreted broadly, and they are intended to illustrate, not to restrict, the example embodiments.

1. An apparatus comprising at least one processor, and at least one memory including computer program code, wherein the at least one memory and the computer program code are configured, with the at least one processor, to cause the apparatus to:
evaluate one or more criteria for relaxed measurement on one or more radio cells, wherein at least a subset of the one or more criteria are associated with at least one signal comprising at least one of: a wake-up signal, a wake-up signal beacon, and a signal measured by a wake-up receiver; and
determine, based on the evaluation, whether the relaxed measurement is allowed.

2. The apparatus according to claim 1, wherein the at least subset of the one or more criteria are evaluated in response to fulfilling at least one of: a low-mobility criterion and a not-at-cell-edge criterion.

3. The apparatus according to claim 1, wherein the one or more criteria are evaluated in response to a path loss of the at least one signal being above or equal to one or more first pre-defined thresholds.

4. The apparatus according to claim 3, wherein the path loss comprises an offset value between a first path loss value and a second path loss value, the first path loss value indicating an average of a first plurality of measured path loss values, and the second path loss value indicating an average of a second plurality of measured path loss values, wherein the second plurality of measured path loss values comprises more recent values than the first plurality of measured path loss values.

5. The apparatus according to claim 1, wherein the one or more criteria comprise at least a criterion for a signal strength of the at least one signal being above or equal to one or more second pre-defined thresholds.

6. The apparatus according to claim 5, wherein the one or more criteria comprise at least a criterion for a variation of the signal strength being less than or equal to one or more third pre-defined thresholds.

7. The apparatus according to claim 1, wherein the one or more criteria comprise at least a criterion for receiving a pre-defined number of signals within a pre-defined time period.

8. The apparatus according to claim 1, wherein the one or more criteria comprise at least a criterion for a number of decoding failures associated with the at least one signal being below or equal to one or more fourth pre-defined thresholds.

9. The apparatus according to claim 1, further being caused to:
initiate the relaxed measurement on the one or more radio cells in response to the one or more criteria being fulfilled based on the evaluation.

10. The apparatus according to claim 1, further being caused to:
stop the relaxed measurement on the one or more radio cells in response to the one or more criteria not being fulfilled based on the evaluation.

11. The apparatus according to claim 10, further being caused to:
transmit, to a network element, an indication indicating the stopping of the relaxed measurement.

12. The apparatus according to claim 1, wherein the at least subset of the one or more criteria are applicable to any of the following: radio resource control connected state, radio resource control idle state, and radio resource control inactive state.

13. The apparatus according to claim 1, wherein the relaxed measurement comprises at least one of: radio resource management relaxation, radio link monitoring relaxation, and beam failure detection relaxation.

14. An apparatus comprising at least one processor, and at least one memory including computer program code, wherein the at least one memory and the computer program code are configured, with the at least one processor, to cause the apparatus to:
indicate, to a user device, one or more criteria for relaxed measurement on one or more radio cells, wherein at least a subset of the one or more criteria are associated with at least one signal comprising at least one of: a wake-up signal, a wake-up signal beacon, and a signal measured by a wake-up receiver of the user device.

15. A method comprising:
evaluating one or more criteria for relaxed measurement on one or more radio cells, wherein at least a subset of the one or more criteria are associated with at least one signal comprising at least one of: a wake-up signal, a wake-up signal beacon, and a signal measured by a wake-up receiver; and
determining, based on the evaluation, whether the relaxed measurement is allowed.

16-18. (canceled)
